(19) United States
(12) Patent Application Publication
(10) Pub. No.: US 2006/0095327 A1
(43) Pub. Date: May 4, 2006

(54) System and method for identifying customer offers

(76) Inventors: Charles A. Vaughn, Greer, SC (US); Leslie B. Alexander, Huntingtown, MD (US); Robert B. Wright, Anderson, SC (US)

Correspondence Address: CALFEE HALTER & GRISWOLD, LLP, 800 SUPERIOR AVENUE, SUITE 1400, CLEVELAND, OH, 44114, US

(21) Appl. No.: 11/261,146

(22) Filed: Oct. 28, 2005

Related U.S. Application Data
(60) Provisional application No. 60/624,117, filed on Nov. 1, 2004.

(51) Int. Cl. G06Q 30/00

(52) U.S. Cl. 705/14

(57) ABSTRACT

A system and method for identifying customer-specific offers by utilizing information on promotions such as vendor allowance programs and information on customer purchase histories are provided. By correlating information on products that are subject to predefined promotions with a customer's purchase history, offers on products, which meet various criteria, are supplied to the customer. The criteria can include, for example, whether the customer has purchased the product in the past, whether the product is discounted through a vendor allowance, and whether the product is not a loss-leader that is used to attract customers to a store.

### CROSS REFERENCE TO RELATED APPLICATION

The present application claims the benefit of U.S. Provisional Application No. 60/624,117 filed Nov. 1, 2004, the disclosure of which is incorporated herein by reference in its entirety.

### FIELD

The present invention generally relates to computer systems and, specifically, to a system and method for filtering customer offers by combining information on promotions and a customer purchase history to identify the relevant offers for the customer.

### BACKGROUND

Conventionally, companies providing packaged goods to consumers offer promotional dollars to retailers of their products. These promotional dollars usually take the form of allowances or discounts per case of a product. For example, a company may lower the cost per case of a product for a retailer, with the expectation that the retailer will pass most or all of the savings per unit to customers and increase the volume of the product at the retailer.

For example, a brand of cookies that has a regular retailer's cost of $2.51 and a retail price of $3.39 provides a gross margin of $0.88 (i.e., 25.9%). If the manufacturer provides a $1.00 allowance, and the retailer decides to sell the cookies for $2.49 as the retail promotion price (a retail price reduction of $0.90), with the regular cost to the retailer at $1.51, then the gross margin is $0.98 (i.e., 39.4%).

Retailers may highlight these discounted products by advertising the discounted retail prices in newspapers and mailers. This conventional approach to delivering promotions to consumers, however, is lacking in many areas. For example, the broadcast of generic promotions by mail is inefficient in that it does not produce a significant rate of participation. Additionally, the cost to print and mail customer-specific offers is substantial. Furthermore, it is expensive to manage, track and reconcile promotions efficiently under this approach.

To solve some of these problems, many retailers have adopted loyalty programs as an electronic method of delivering coupons (i.e., price discounts). These programs often utilize loyalty cards or other means of identifying a customer or an associated group or family of customers that have registered their personal information with the store or chain and received a loyalty membership. These programs are beneficial in that paper coupons directed to customers are eliminated, and members' purchasing habits can be monitored. However, a loyalty membership program in itself does not provide a mechanism for identifying customer-specific offers based on brand purchases.

Indeed, most attempts to deliver customer-specific offers have focused on cross-selling items as a means to increase basket size. For example, offering a first brand of toothpaste to a shopper who has previously purchased a second brand of toothpaste, with the hope that the shopper will be influenced to buy a different brand of product (e.g., the first brand of toothpaste) based solely on price. This approach fails to address the consumer's loyalty to a particular brand (e.g., the second brand of toothpaste). Additionally, many of these cross-marketing schemes are delivered at the checkout stand after the shopper has paid for purchases and is leaving the store.

### SUMMARY

It is one aspect to provide a system for identifying customer-specific offers by utilizing information on vendor allowance programs, in-store promotions or other types of discounts and information on customer purchase histories. As used herein, “vendor” refers to a person or entity selling a product or products to a retailer. For example, a vendor can be a manufacturer, a consumer package good (CPG) company, a broker, a wholesaler, a reseller, etc.

By correlating promoted products with a customer's purchase history, information on products that meet various criteria is filtered out and may be supplied to the customer. The criteria can include, for example, whether the customer has purchased the product in the past, whether the product is discounted through a vendor allowance, in-store promotion or the like, and whether the product is not a loss-leader. A loss-leader is a product that is offered at a price which is near or even below the retailer's cost. These loss-leader products are offered to attract shoppers in the hope that the shoppers will purchase other regularly priced items while in the store. Once in the store, the retailer would prefer that a shopper not purchase the loss-leader products.

It is another exemplary aspect to provide a method for identifying customer-specific offers by utilizing information on vendor allowance programs, in-store promotions or other discounts and information on customer purchase histories.

In another exemplary aspect, the product information is provided to the customer in the form of a shopping list. The shopping list can be provided to the customer, for example, via a kiosk located in the store being visited by the customer. The shopping list can be provided to the customer by any sufficient means, such as on a display, in an e-mail, on a web site, as a printout, via regular mail, etc. In this manner, predefined offers that correspond to items that the customer has purchased in the past are presented to the customer on demand, usually during the period of time when they are shopping or preparing to shop.

### DESCRIPTION OF THE DRAWINGS

The above and additional aspects, features and advantages will become more apparent by describing in detail exemplary embodiments with reference to the attached drawings, in which:

FIG. 1 is a diagram illustrating a list of filtered offers formed from data retrieved from a vendor promotion database and a customer purchase history database;

FIG. 2 is a diagram illustrating a screen of a kiosk with offers displayed thereon;

FIG. 3 is a diagram illustrating offer information to appear on a printed shopping list;

FIG. 4 is a diagram illustrating a plurality of kiosks, which are in communication with one another, distributed among several retail stores;

FIG. 5 is a diagram of a system for filtering customer offers, according to an exemplary embodiment; and

FIG. 6 is a flowchart illustrating a method of filtering customer offers, according to an exemplary embodiment.

### DESCRIPTION OF EXEMPLARY EMBODIMENTS

Hereinafter, exemplary embodiments will be described in detail with reference to the accompanying drawings.

Generally, hundreds of promotions may be active for a store or chain at any given time. Some of the promotions may be applicable to all customers, while some of the promotions may be applicable to only a select class of customers (e.g., customers having a loyalty membership with the store or chain). The promotions may be identified, for example, within the store (e.g., by shelf labels), outside the store (e.g., by a newspaper insert) or both.

By filtering the promotions based on prior purchasing habits of a customer (e.g., a loyalty cardholder), a list including or limited to those promotions relating to items previously and/or recently purchased by the customer may be delivered to the customer. Such a list may aid the customer in identifying promotions relating to items for which the customer has shown a preference, without overwhelming or annoying the customer with a multitude of promotions for items in which the customer is not interested.

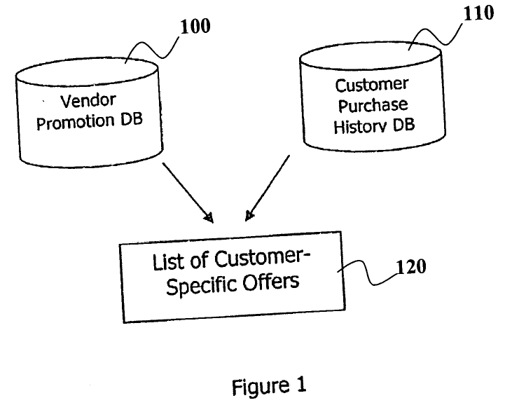

FIG. 1 is a diagram illustrating a list of customer-specific offers formed from data retrieved from a vendor promotion database 100 and a customer purchase history database 110.

In FIG. 1, the vendor promotion database 100 stores information on current vendor promotions and the customer purchase history database 110 stores information on the purchasing habits of customers. Discount types other than vendor promotions (e.g., in-store promotions) could be stored in the vendor promotion database 100 or in a separate database. As an example, a discount may be an automatic savings on an item realized at checkout, and may be limited to a particular class of customers (e.g., loyalty cardholders).

The vendor promotion database 100 and the customer purchase history database 110 may be located in different stores, cities, regions, states, etc. from one another. Furthermore, although shown as separate data stores, the vendor promotion database 100 and the customer purchase history database 110 can be the same data store.

In an exemplary embodiment, a computer within a store collects and stores the information on the purchasing habits of a customer in the customer purchase history database 110. For example, the computer and/or one or more of the databases 100, 110 can be located within a kiosk in the store. The kiosk itself, or another computer in the store, captures and catalogs purchase information from the store's “loyal” customers, i.e., those having a store (or chain) issued loyalty membership, which is confirmed at checkout. The customer's purchase information can be subsequently extracted from the transaction log. This extracted data is associated with information for identifying the customer (e.g., the customer's loyalty number) and stored in a database (e.g., customer purchase history database 110) at the kiosk location or on another computer in the store.

Thereafter, a customer can use the computer within the kiosk, when he/she enters the store, to get a list of customer-specific offers 120 within the store relevant to him/her based on his/her purchasing behavior. The list of customer-specific offers 120 is generated by correlating the customer's buying information with the information on the vendor promotions. For example, when the customer next enters the store, if he/she presents his/her loyalty card or other information identifying him/her as a loyalty member of that store or chain at the kiosk location, a suggested shopping list with the applicable discounts is presented, and optionally printed, to the customer. Alternatively, the shopping list could be transmitted (e.g., wirelessly) to a personal electronic device of the customer, such as a personal digital assistant (PDA) or personal scanner. This list highlights items that the consumer is known to have purchased previously, and which are being promoted by the store, for example, by a vendor's discount. The list of customer-specific offers may optionally include expiration dates for one or more of the offers. Accordingly, while the customer may qualify for numerous (e.g., more than 500) discounts storewide or chainwide as a loyalty member, the customer can obtain a list of discounts on a few (e.g., 20 or less) items that the customer prefers, as evidenced by the customer's purchase history.

In this exemplary embodiment, the makeup of the shopping list remains flexible. For example, the shopping list may include a configurable header and/or footer. Additionally, the presentation of offers recently presented to a specific customer can be avoided, such that the customer does not see “stale” offers recently shown. Furthermore, alternate items may be included if desired. If a customer lacks a sufficient buying history to deliver the desired number of promotional offers, predetermined generic offers may be presented to the customer. A generic offer, for example, is an offer that involves a product that the customer may not have purchased in the past, an offer to promote a department, product category, seasonal special, etc. within the store, or an offer based on cost or margin. Additionally, these generic offers may be presented to non-loyalty shoppers. This flexibility is valuable to the retailer because it allows the retailer to adapt to store-specific situations, such as the need to place overstocked perishables on sale.

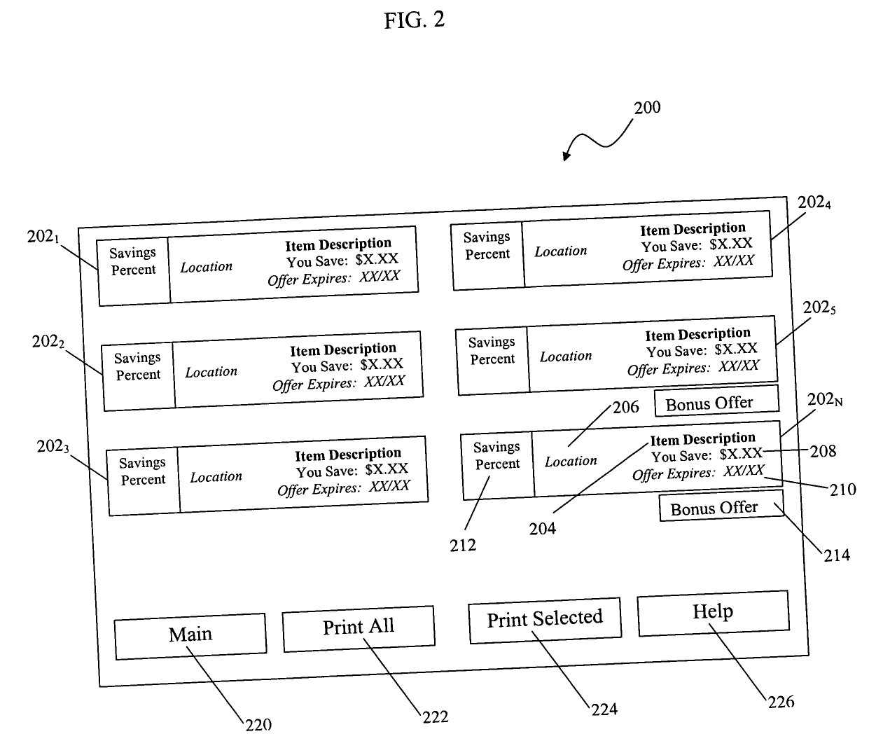

An exemplary arrangement of a screen of a kiosk in a store is shown in FIG. 2. In FIG. 2, an offer screen 200 of the kiosk displays one or more offers 202₁ to 202_{N} and command buttons 220, 222, 224 and 226.

For each offer 202₁ to 202_{N}, information relevant to the offer is displayed. For example, an offer may include an item description 204, a location of the item in the store 206, an amount of money saved 208 and a savings percentage 212. Optionally, a time and/or date when an offer expires 210 is displayed with each offer 202. As another option, the location information 206 is only displayed if data on the location of the item is available. Additionally, generic items may include a “Bonus Offer” indicator 214. Such an indicator could be used for other item types and for other reasons.

Command buttons displayed on the offer screen 200 include a “Main” button 220, a “Print All” button 222, a “Print Selected” button 224 and a “Help” button 226. These buttons are merely exemplary and more or fewer buttons, including different buttons, could be used.

By interacting with the “Main” button (e.g., by using a pointing device), a user can navigate from the offer screen 200 back to a main screen/menu (not shown). The “Print All” button allows the user to print all of the displayed offers 202₁ to 202_{N}. The “Print Selected” button allows the user to print one or more offers previously selected from a plurality of displayed offers, wherein the selection of an offer is achieved by, for example, clicking the offer, double-clicking the offer, highlighting the offer, using radio buttons, etc. The “Help” button allows the user to request help using the system.

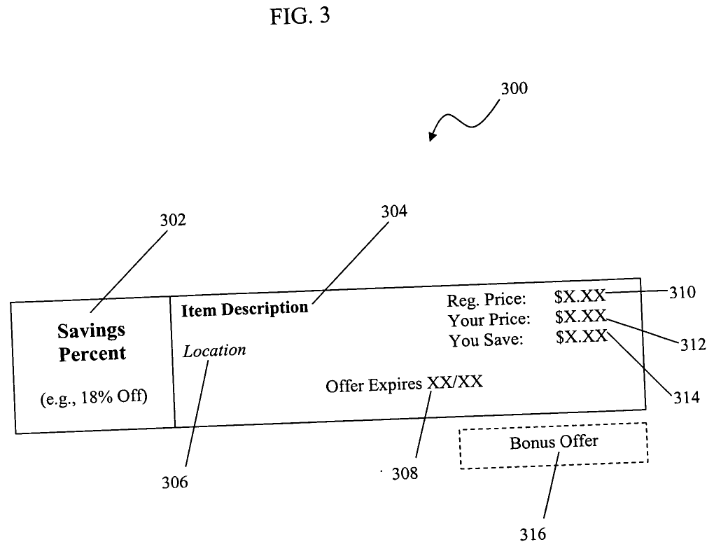

The offers may be printed in the form of a shopping list. In an exemplary embodiment, the printed shopping list will include particular information for each item on the list, as illustrated in FIG. 3. As shown in FIG. 3, an item 300 in the printed shopping list includes a savings percentage 302, an item description 304, a location of the item 306, a regular price 310, a retail price 312, and an amount of money saved 314. Optionally, a time and/or date when an offer expires 308 is displayed for each item 300. As another option, the location information 306 is only displayed if data on the location of the item is available. Additionally, generic items may be identified by a “Bonus Offer” indicator 316.

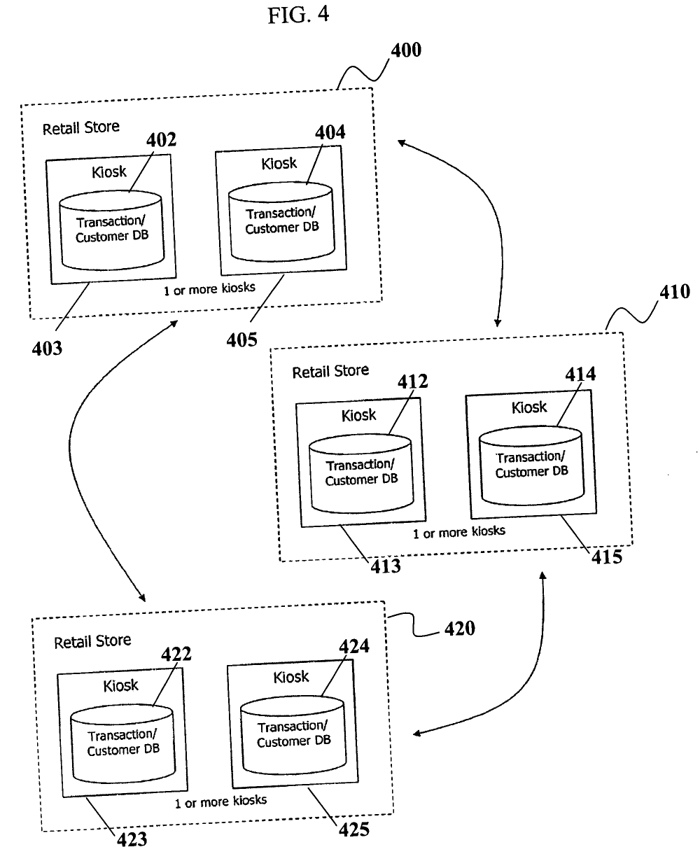

As shown in FIG. 4, a plurality of kiosks, which are in communication with one another, may be distributed among several retail stores.

In another exemplary embodiment, a kiosk shares and updates customer data and/or transaction data with other kiosk locations and/or with a headquarters system (e.g., an enterprise home office). For example, a first store 400 includes kiosks 403, 405 having transaction/customer databases 402, 404, respectively; a second store 410 includes kiosks 413, 415 having transaction/customer databases 412, 414, respectively; and a third store 420 includes kiosks 423, 425 having transaction/customer databases 422, 424, respectively. By virtue of the stores being in communication with one another, the customer data in one kiosk may be accessed from another store. The stores may be in communication with one another, for example, via a wired or wireless network (not shown). In this exemplary embodiment, data relating to the actual presented promotions and their effect on customer purchasing may also be collected and processed.

By dividing the processing tasks involved among computers located where the customers make their purchases, the immense power represented by these multiple computers is brought to bear on tasks that otherwise might have to be done in large centrally located data centers. This technique eliminates the need for a large central data store and their computers and reduces communications traffic and overhead. However, it will be appreciated that other embodiments may include a central data store and centralized processing along with remote user access terminals (e.g., kiosks). It will be further appreciated that processing power and data storage is optionally split between centralized, regional and/or independent (i.e., remote) implementations.

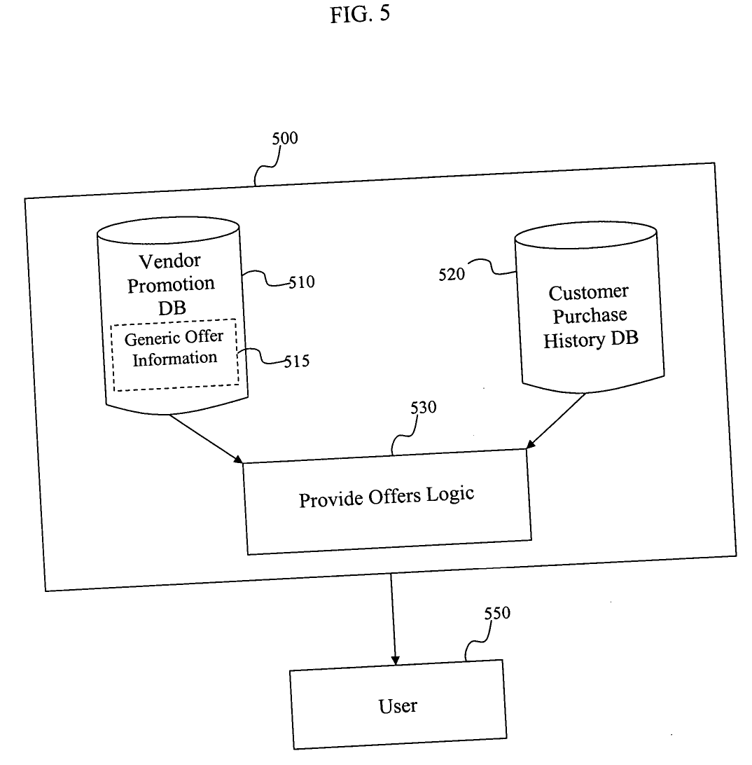

FIG. 5 is a diagram of a system 500 for filtering customer offers, according to an exemplary embodiment.

In this exemplary embodiment, system 500 includes a vendor promotion database 510 (which may include generic offer information 515), a customer purchase history database 520, and provide offers logic 530. The system 500 is accessed by a user 550, as described herein.

The vendor promotion database 510 is any suitable database for storing and retrieving information regarding promotion(s), often price discounts, for one or more items (products) available to the user 550. The promotions may be applicable to all customers (e.g., generic offers) or only a special class of customers (e.g., loyalty members). The vendor promotion database 510 is optionally located in one or more centralized processing centers, in one or more regional processing centers, and/or in individual kiosks and/or one or more computers at user-purchasing locations. The vendor promotion database 510 contains information regarding at least one promotion relating to at least one product which is available at a user-purchasing location. The information on a promoted item, which is stored in the vendor promotion database 510, may include, for example, information on the item itself (item name, item description, item category, number of items per case, etc.), information on pricing of the item (cost of a case, regular price of the item, discounted price of the item, savings percentage, etc.), and the like.

The information on a promoted item, which is stored in the vendor promotion database 510, may optionally include information on where the item is located (department, aisle, shelf position, etc.). Alternatively, the information on the where the item is located may be provided from a separate and/or dedicated source. For example, a tracking system that stores information on the location of items may be provided. If the tracking system is queried with information identifying an item (e.g., a UPC number of the item), the tracking system returns information on where the item is located. The information on where a promoted item is located may be used, for example, to assist a shopper in finding the promoted item within the store.

Preferably, but not necessarily, the vendor promotion database 510 stores a plurality of promotions from a plurality of vendors regarding a plurality of products. As a further option, the vendor promotion database 510 may store information for generic offers. Such promotional information is input to the vendor promotion database 510 by any suitable manner, including but not limited to by a store owner/operator, a system 500 operator/maintainer, and one or more vendors. The vendor promotion database 510 is optionally frequently updated to include new promotions and remove old promotions.

The vendor promotion database 510 optionally contains information regarding which products are available in purchasing locations at which the user 550 accesses the system 500, since all products sold by a retail chain may not be for sale at all stores. Additionally, the vendor promotion database 510 optionally contains information regarding products which are available in the purchasing location at which the user 550 accesses the system, such as dietary information, location of the item within the store, and other such information as may be pertinent to the customer's buying decision or the retailer's other item data. In an exemplary embodiment, wherein a plurality of vendor promotions databases 510 are networked together or wherein one or more vendor promotion databases 510 services a plurality of purchasing locations with varying products, the vendor promotion database 510 further optionally contains information regarding products which are available in at least one purchasing location linked to the network.

The customer purchase history database 520 is any suitable database for storing and retrieving information regarding a purchase history of at least one customer. The customer purchase history database 520 is optionally located in one or more centralized processing centers, in one or more regional processing centers, and/or in individual kiosks and/or one or more computers at user-purchasing locations. The customer purchase history database 520 contains information regarding at least one purchase by at least one customer (e.g., user 550), regarding at least one product which was purchased previously by the customer. The information on a customer's purchase history, which is stored in the customer purchase history database 520, may include, for example, information on the customer (a customer identifier, a customer name, a customer type, etc.) and information on an item that was previously purchased by the customer (an item identifier, a total count of the item purchased, a time the item was last purchased, a count of the item as last purchased, etc.), and the like.

Preferably, but not necessarily, the customer purchase history database 520 stores a plurality of purchases (e.g., a purchase history) for a plurality of customers. Such purchase history is input to the customer purchase history database 520 by any suitable manner, for example, by extracting from transaction logs information on purchases made using loyalty cards or other identifying information as described herein. In an exemplary embodiment, wherein at least one customer purchase history database 520 exists in a plurality of purchasing locations, it will be appreciated that the information in the customer purchase history databases 520 is optionally shared among and between the systems 500 in the different purchasing locations.

The provide offers logic 530 includes any suitable steps, methods, processes and/or software for indicating at least one promotional offer to the user 550 based upon the user's purchase history contained in the customer purchase history database 520 and any promotional offers regarding the products in the purchase history as contained in the vendor promotion database 510. It will be appreciated that the provide offers logic 530 optionally includes one or more logical components for facilitating the indication of such offers, examples of which are illustrated below.

The provide offers logic 530 optionally includes obtain customer identity logic (“OCI logic”). The OCI logic includes any suitable steps, methods, processes and/or software for obtaining the identity of a customer (e.g., user 550). For example, if a customer loyalty card is used, a customer identity is obtained when the customer swipes or presents the loyalty card (e.g., at a kiosk). Other suitable forms of identification can be presented by or obtained from a customer, such as identification documents, barcode encoded cards, magnetic strip cards, biometric identifiers, etc. The OCI logic optionally accesses any suitable database containing information regarding customers who hold loyalty cards.

The provide offers logic 530 further optionally includes obtain purchase history logic (“OPH logic”). The OPH logic includes any suitable steps, methods, processes and/or software for obtaining information regarding the purchase history of the customer identified via the OCI logic. For example, upon obtaining a customer identity, the OPH logic accesses the customer purchase history database 520 to retrieve the purchase history (if any) of that customer as stored in the customer purchase history database 520.

The OPH logic also optionally includes any suitable steps, methods, processes and/or software for providing offers to customers when little or no purchase history is present. For example, if a customer lacks a sufficient buying history to produce a desired number of offers based on the previous buying history, predetermined generic offers may be obtained for presentation to the customer. Additionally, generic offers can be presented in place of or in addition to offers based on previous buying history. The OPH logic also optionally includes any suitable steps, methods, processes and/or software for obtaining offers for presentation to costumers based upon other criteria, such as department, item category, item cost, item margin, etc.

Additionally, the OPH logic also optionally includes any suitable steps, methods, processes and/or software for excluding certain items or item categories, based upon criteria set by the retailer. This allows the retailer, for example, to avoid providing some generic offers to newer customers that the customers may find offensive (e.g., alcoholic beverages, contraceptives, etc.).

In an exemplary embodiment, wherein customer purchase information is stored in a plurality of customer purchase history databases 520, the OPH logic accesses a plurality of customer purchase history databases 520 to obtain a purchase history. It will be appreciated that any part, or all, of the customer's purchase history is retrieved for further processing. A customer's purchase history includes, for example, items previously purchased by the customer and the number of times each item has been purchased by the customer. An item is removed from the customer's purchase history if it is not purchased again within a configurable length of time.

The provide offers logic 530 further optionally includes determine promotional offers logic (“DPO logic”). The DPO logic includes any suitable steps, methods, processes and/or software for obtaining vendor promotional offers from the vendor promotion database 510 for any products identified by the OPH logic as being in user 550's purchase history. For example, upon receiving a customer's purchase history (including a list of all or some of the products previously purchased by the customer), the DPO logic searches the vendor promotion database 510 for promotions which are available for any or all of the products in the customer's history. In a case where there is insufficient purchase history for a customer present in the purchase history database 520 to create a list of promoted items from the vendor promotion database 510, an optional list of generic items may be presented to replace or supplement those within the purchase history database 520. The DPO logic retrieves one or more promotions for one or more products in the user's purchase history (e.g., by searching the vendor promotion database 510 by product, as listed in the purchase history of the user 550).

The DPO logic optionally includes determine offer expiration logic (“DOE logic”). The DOE logic includes any suitable steps, methods, processes and/or software for determining whether an offer from the vendor promotion database 510 will expire, when the offer will expire and/or whether the offer has already expired.

The DPO logic optionally includes determine effective offer logic (“DEO” logic). The DEO logic includes any suitable steps, methods, processes and/or software for determining whether an offer from the vendor promotion database 510 is active based on an effective start date.

The provide offers logic 530 further optionally includes output promotional offers logic (“OPO logic”). The OPO logic includes any suitable steps, methods, processes and/or software for outputting one or more promotions retrieved via the DPO logic. For example, the OPO logic identifies one, more than one or all of the promotions retrieved by the DPO logic for delivery to the user 550. The OPO logic provides a list of such promotions by any suitable method, including but not limited to by printed list, screen display, e-mail, data transmission (e.g., downloading the list to a (PDA) or other electronic device), etc. Accordingly, the user 550 is readily presented with a list of those products that are of interest to the user 550 and currently subject to a promotion.

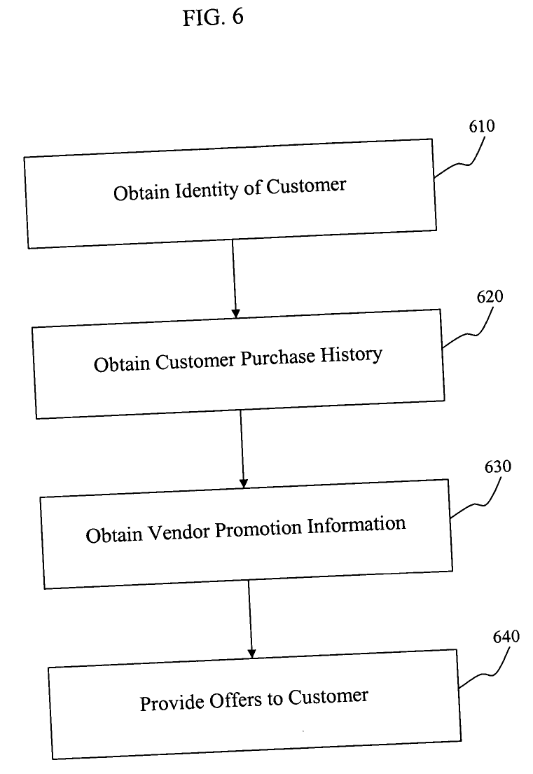

FIG. 6 is a flowchart illustrating a method of filtering customer offers, according to an exemplary embodiment.

In this exemplary embodiment, a method for filtering customer offers is provided. At block 610, the identity of at least one customer is obtained by any suitable method, including but not limited to the use of a loyalty card by the customer as described herein. At block 620, a purchase history of the customer identified in block 610 is obtained. The purchase history includes at least one, and optionally a plurality, of products previously purchased by the customer. At block 630, promotions regarding at least one of the products in the customer's purchase history are obtained. Current promotions for all products in the customer's purchase history are optionally obtained. At block 640, the list of promotional offers culled at block 630 are provided to the customer, for example, in the form of a shopping list. The customer may thus use the list to identify promotional offers on products they have previously purchased.

As used herein, “logic” is used generically and includes but is not limited to hardware, software and/or combinations of both to perform a function. As used herein, “software” is used generically and includes but is not limited to one or more computer executable instructions, routines, algorithms, modules or programs including separate applications or from dynamically linked libraries for performing functions as disclosed herein. Software may also be implemented in various forms such as a servlet, applet, stand-alone, plug-in or other type of application. Software can be maintained on various computer readable mediums as known in the art.

While the above description references exemplary embodiments, it should be understood by those skilled in the art that various changes may be made and equivalents may be substituted for elements thereof without departing from the spirit and the scope of applicants' general inventive concept. For example, while various embodiments have been described herein as using loyalty-card programs to identify a customer's purchase history, it will be appreciated that any frequently used customer identifier would suffice, such as a credit card number, e-mail address, phone number, biometric ID, digital signature, etc.

It should be further understood that the exemplary embodiments set forth above are not intended to limit the scope of the invention or the claims set forth below in any way. In particular, the words and language of the claims have their full, ordinary meanings in defining the inventions indicated therein.

We claim:

1. A method of filtering a plurality of predefined promotions, the method comprising:
obtaining identity information that identifies a customer;
using the identity information to obtain purchase information for a product purchased previously by the customer; and
selecting at least one of the plurality of predefined promotions based on the previously purchased product.

2. The method of claim 1, wherein the plurality of predefined promotions are vendor promotions.

3. The method of claim 1, wherein the plurality of predefined promotions exceeds five hundred predefined promotions.

4. The method of claim 1, further comprising outputting information relating to the selected predefined promotions.

5. The method of claim 4, wherein outputting the information relating to the selected predefined promotions comprises printing the information.

6. The method of claim 4, wherein outputting the information relating to the selected predefined promotions comprises displaying the information.

7. The method of claim 4, wherein outputting the information relating to the selected predefined promotions comprises transmitting the information.

8. The method of claim 4, wherein the information relating to the selected predefined promotions is output as a shopping list.

9. The method of claim 8, wherein the shopping list includes twenty or fewer predefined promotions.

10. The method of claim 8, wherein the shopping list includes generic promotion information on at least one generic promotion.

11. The method of claim 8, wherein the shopping list includes at least one of a predetermined header and a predetermined footer.

12. The method of claim 1, wherein the identity information is associated with a loyalty membership of the customer for a store or a chain of stores.

13. The method of claim 1, wherein the identity information is obtained from at least one of an identification document, a bar encoded card, a magnetic strip card, a personal electronic device and a biometric identifier.

14. The method of claim 1, wherein the identity information, the purchase information and the information relating to the predefined promotions are stored in at least one database.

15. A system for filtering a plurality of predefined promotions, the system comprising:
a first database for storing purchase information on a product purchased previously by a customer; and
a second database for storing promotion information for a plurality of predefined promotions;
offer logic for determining if at least one of the predefined promotions corresponds to the product previously purchased by the customer.

16. The system of claim 15, wherein the plurality of predefined promotions are vendor promotions.

17. The system of claim 15, wherein the plurality of predefined promotions exceeds five hundred predefined promotions.

18. The system of claim 15, wherein the offer logic comprises customer identity logic for obtaining identity information that identifies the customer.

19. The system of claim 18, wherein the identity information is associated with a loyalty membership of the customer for a store or a chain of stores.

20. The system of claim 18, wherein the identity information is obtained from at least one of an identification document, a bar encoded card, a magnetic strip card, a personal electronic device and a biometric identifier.

21. The system of claim 18, wherein the offer logic further comprises purchase history logic for retrieving the purchase information related to products previously purchased by customers from the first database based on the identity information obtained by the customer identity logic.

22. The system of claim 21, wherein the offer logic further comprises determine promotion logic for using the purchase information to search the second database to determine if the at least one of the predefined promotions corresponds to the product previously purchased by the customer.

23. The system of claim 22, wherein the offer logic further comprises output promotion logic for outputting the promotion information for the at least one of the predefined promotions that corresponds to the product previously purchased by the customer.

24. The system of claim 23, wherein the promotion information is output as a shopping list.

25. The system of claim 24, wherein the shopping list includes twenty or fewer predefined promotions.

26. The system of claim 24, wherein the shopping list includes generic promotion information on at least one generic promotion.

27. The system of claim 24, wherein the shopping list includes at least one of a predetermined header and a predetermined footer.

28. The system of claim 15, wherein the offer logic comprises determine offer expiration logic for determining if at least one of the predefined promotions has expired based on expiration information associated with the at least one of the predefined promotions.

29. The system of claim 28, wherein the expiration information includes an expiration date.

30. The system of claim 15, wherein the offer logic comprises determine effective offer logic for determining if at least one of the predefined promotions is active based on activation information associated with the at least one of the predefined promotions.

31. The system of claim 30, wherein the activation information includes an effective start date.

32. The system of claim 15, wherein the first database and the second database are the same database.
